(19) United States
(12) Patent Application Publication
(10) Pub. No.: US 2024/0248496 A1
(43) Pub. Date: Jul. 25, 2024

(54) FLUID CONTROL DEVICE, FLUID CONTROL SYSTEM, FLUID CONTROL DEVICE PROGRAM, AND FLUID CONTROL METHOD

(71) Applicant: HORIBA STEC, Co., Ltd., Kyoto-shi, Kyoto (JP)

(72) Inventors: Kazuhiro MATSUURA, Kyoto-shi (JP); Kentaro NAGAI, Kyoto-shi (JP); Sota MATSUMOTO, Kyoto-shi (JP)

(21) Appl. No.: 18/560,174

(22) PCT Filed: Mar. 11, 2022
(86) PCT No.: PCT/JP2022/010980

§ 371 Date: Nov. 10, 2023

(30) Foreign Application Priority Data
May 13, 2021 (JP) 2021-081562

(51) Int. Cl. G05D 7/06

(52) U.S. Cl. CPC G05D 7/0623; G05D 7/0652

(57) ABSTRACT

A fluid control device in which a fluid control valve, an upstream pressure sensor, a fluid resistance element, and a downstream pressure sensor are arranged in this order from an upstream side, includes: an actual flow rate calculation unit that calculates a flow rate on basis of pressures measured by the upstream pressure sensor and the downstream pressure sensor; a delayed flow rate calculation unit that calculates a delayed flow rate by generating a response delay in the calculated flow rate calculated by the actual flow rate calculation unit; and a flow rate output unit that compares an absolute difference between a predetermined reference value and the calculated flow rate and an absolute difference between the reference value and the delayed flow rate, and outputs the calculated flow rate or the delayed flow rate having a smaller absolute difference.

### TECHNICAL FIELD

The present invention relates to a fluid control device and the like.

### BACKGROUND ART

As a conventional fluid control device, as shown in Patent Literature 1, there is a differential pressure type mass flow controller in which a fluid control valve, an upstream pressure sensor, a fluid resistance element, and a downstream pressure sensor are arranged in this order from the upstream side.

Here, for example, in a semiconductor manufacturing system, a configuration is considered in which the above-described mass flow controller is disposed in at least one of a plurality of flow paths provided in parallel, and the downstream of these flow paths is connected to, for example, a process flow path connected to a process chamber.

In such a system, when a large flow flows into the process flow path in a state where the fluid control valve is closed, the fluid may flow back from the process flow path to the mass flow controller. Then, the pressure measured by the downstream pressure sensor increases, and the pressure measured by the upstream pressure sensor increases by a time difference caused by the fluid resistance element. As a result, a difference occurs between the pressures measured by the upstream pressure sensor and the downstream pressure sensor, and thus an unexpected flow rate corresponding to the pressure difference is output as a measured value even though the fluid control valve is closed.

As a cause of the unexpected output of the flow rate, the following is also exemplified. That is, in the above-described system, a shut-off valve is provided downstream of the mass flow controller, and when the shut-off valve is opened from a state in which both the shut-off valve and the fluid control valve are closed, the fluid remaining inside the mass flow controller or the like flows out to the process flow path. Then, the pressure measured by the downstream pressure sensor decreases, and the pressure measured by the upstream pressure sensor decreases by a time difference caused by the fluid resistance element. As a result, a difference occurs between the pressures measured by the upstream pressure sensor and the downstream pressure sensor, and thus, a flow rate corresponding to the pressure difference is output even though the fluid control valve is closed.

Such a problem can occur not only in the semiconductor manufacturing system but also in various fluid control systems.

Therefore, as a method of suppressing the flow rate that is unexpectedly output, for example, it is conceivable to generate a first-order delay in the flow rate that is output using a low-pass filter.

However, in this case, although the output flow rate can be suppressed, since a time delay is generated in the output flow rate, there arises another problem of an extended time for stabilizing the flow rate.

### CITATION LIST

### Patent Literature

Patent Literature 1: JP 2016-102807 A

### SUMMARY OF INVENTION

### Technical Problem

Therefore, the present invention has been made to solve the above problems, and a main object thereof is to quickly stabilize an output flow rate while suppressing an unintentionally output flow rate.

### Solution to Problem

A fluid control device according to the present invention in which a fluid control valve, an upstream pressure sensor, a fluid resistance element, and a downstream pressure sensor are arranged in this order from an upstream side, includes: an actual flow rate calculation unit that calculates a flow rate on basis of pressures measured by the upstream pressure sensor and the downstream pressure sensor; a delayed flow rate calculation unit that calculates a delayed flow rate by generating a response delay in the calculated flow rate calculated by the actual flow rate calculation unit; and flow rate output unit that compares an absolute difference between a predetermined reference value and the calculated flow rate and an absolute difference between the reference value and the delayed flow rate, and outputs the calculated flow rate or the delayed flow rate having a smaller absolute difference.

According to such a fluid control device, since the flow rate output unit outputs the flow rate having the smaller absolute difference from the reference value among the calculated flow rate and the delayed flow rate, when the unexpected flow rate is output (hereinafter, this phenomenon is also referred to as a burst), the delayed flow rate closer to the reference value than the calculated flow rate is output at the beginning. Thereafter, since the calculated flow rate is more quickly stabilized, the calculated flow rate overtakes the delayed flow rate and approaches the reference value at a certain time point, and from that time point, a calculated flow rate that is quickly stabilized is output.

As described above, according to the fluid control device of the present invention, the delayed flow rate closer to the reference value than the calculated flow rate is output at the beginning of the burst, and the calculated flow rate that is rapidly stabilized from a certain time point at which the absolute difference from the reference value is reversed is output, whereby it is possible to quickly stabilize the output flow rate while suppressing the accidentally output flow rate.

Meanwhile, in a state where the fluid control valve is closed, the output calculated flow rate (that is, the output value) should be zero, and at first glance, it may seem that the reference value described above may be set to zero.

However, the output value in the state in which the fluid control valve is closed may vary slightly over time.

Therefore, as shown in FIG. 9, if the output value in a state where the fluid control valve is closed is shifted to a value smaller than zero, the calculated flow rate becomes closer to zero than the delayed flow rate at the beginning of the burst occurrence while the reference value is set to zero, so that the calculated flow rate is output and the waveform (solid line in FIG. 9) of the output flow rate becomes irregular.

Therefore, it is preferable that a reference value update unit that updates the reference value at predetermined time intervals is further provided.

With such a configuration, the reference value can be continuously set to an appropriate value, and an appropriate waveform can be output.

It is preferable that the reference value update unit samples the calculated flow rate over a predetermined time, and updates one of the sampled calculated flow rates as a new reference value when an absolute difference between the calculated flow rate and the reference value falls below an update threshold over the predetermined time.

With such a configuration, a stable output value at that time in a state where the fluid control valve is closed can be updated as the reference value.

For example, immediately after the shut-off valve or the fluid control valve provided on the upstream side of the fluid control device is closed, the calculated flow rate is not immediately stabilized, and if the reference value is set or updated in the transient state, the calculated flow rate output in the unstable state may be set as the reference value.

Therefore, it is preferable to further include a stable state determination unit that determines that the calculated flow rate is in a stable state when an absolute difference between the calculated flow rate and the reference value falls below a stable state threshold over a predetermined time, and to start sampling the calculated flow rate by the reference value update unit after the stable state determination unit determines that the calculated flow rate is in the stable state.

With such a configuration, sampling of the calculated flow rate by the reference value update unit is not started until the calculated flow rate is stabilized, and it is possible to prevent the calculated flow rate in an unstable state from being set as the reference value.

As described above, since the calculated flow rate is unstable immediately after the fluid control valve is closed, it is preferable that the function of the flow rate output unit is not exerted at this time point.

On the other hand, immediately after the fluid control valve is opened, there is a possibility that the fluid remaining inside flows backward to the upstream side and the flow rate on the negative side is unexpectedly output and it is preferable to keep exerting the function of the flow rate output unit in order to suppress this burst.

It is therefore preferable to further include a switching unit that switches whether or not to cause the flow rate output unit to compare the absolute differences.

With such a configuration, the function of the flow rate output unit can be enabled or disabled at an appropriate timing.

It is preferable that the switching unit enables a function of the flow rate output unit when the fluid control valve is in a closed state and an absolute difference between the calculated flow rate and the reference value falls below an enablement determination threshold.

With such a configuration, immediately after the fluid control valve is closed, the function of the flow rate output unit can be enabled after the calculated flow rate is stabilized.

It is preferable that the switching unit disables a function of the flow rate output unit when the fluid control valve is in an open state and a value obtained by subtracting the pressure measured by the downstream pressure from the pressure measured by the upstream pressure sensor exceeds a disablement determination threshold.

With such a configuration, immediately after the fluid control valve is opened, it is possible to disable the function of the flow rate output unit after there is no possibility of the burst due to the reverse flow of the fluid remaining inside, in other words, it is possible to suppress the burst due to the reverse flow described above.

How much the user intends to suppress the burst may be different between the burst appearing on the positive side and the burst appearing on the negative side.

In order to respond to such a demand, it is preferable that a time constant of the response delay generated by the delayed flow rate calculation unit is different between a case where a fluid flows from the upstream side to a downstream side in the fluid resistance element and a case where a fluid flows in a direction opposite thereto.

In addition, in a fluid control system according to the present invention, the above-described fluid control device is disposed in a part or all of a plurality of branch flow paths connected to a main flow path and provided in parallel.

Such a fluid control system can achieve the same effects as those of the fluid control device described above.

A program according to the present invention used for a fluid control device in which a fluid control valve, an upstream pressure sensor, a fluid resistance element, and a downstream pressure sensor are arranged in this order from an upstream side, causes a computer to function as: an actual flow rate calculation unit that calculates a flow rate on basis of pressures measured by the upstream pressure sensor and the downstream pressure sensor; a delayed flow rate calculation unit that calculates a delayed flow rate by generating a response delay in the calculated flow rate calculated by the actual flow rate calculation unit; and flow rate output unit that compares an absolute difference between a predetermined reference value and the calculated flow rate and an absolute difference between the reference value and the delayed flow rate, and outputs the calculated flow rate or the delayed flow rate having a smaller absolute difference.

Further, a fluid control method according to the present invention used for a fluid control device in which a fluid control valve, an upstream pressure sensor, a fluid resistance element, and a downstream pressure sensor are arranged in this order from an upstream side, includes: an actual flow rate calculation step of calculating a flow rate on basis of pressures measured by the upstream pressure sensor and the downstream pressure sensor; a delayed flow rate calculation step of calculating a delayed flow rate by generating a response delay in the calculated flow rate calculated in the actual flow rate calculation step; and a step of comparing an absolute difference between a predetermined reference value and the calculated flow rate and an absolute difference between the reference value and the delayed flow rate, and outputting the calculated flow rate or the delayed flow rate having a smaller absolute difference.

Such a fluid control device program and fluid control method can achieve the same effects as those of the fluid control device described above.

### Advantageous Effects of Invention

According to the present invention described above, it is possible to quickly stabilize the output flow rate while suppressing the accidentally output flow rate.

### BRIEF DESCRIPTION OF DRAWINGS

FIG. 1 is a schematic diagram illustrating a configuration of a fluid control system according to an embodiment of the present invention.

FIG. 2 is a schematic diagram illustrating a configuration of a fluid control device according to the embodiment.

FIG. 3 is a graph showing a flow rate (burst) unexpectedly output.

FIG. 4 is a functional block diagram illustrating functions of a control unit according to the embodiment.

FIG. 5 is a graph illustrating a delayed flow rate calculated by a delayed flow rate calculation unit according to the embodiment.

FIG. 6 is a graph showing a flow rate output by the flow rate output unit according to the embodiment.

FIG. 7 is a flowchart illustrating operations of a stable state determination unit and a reference value update unit according to the embodiment.

FIG. 8 is a flowchart illustrating an operation of a switching unit according to the embodiment.

FIG. 9 is a graph showing a flow rate that can be output when a reference value is kept at zero.

### DESCRIPTION OF EMBODIMENTS

Hereinafter, a fluid control device according to an embodiment of the present invention will be described with reference to the drawings.

### <Device Configuration>

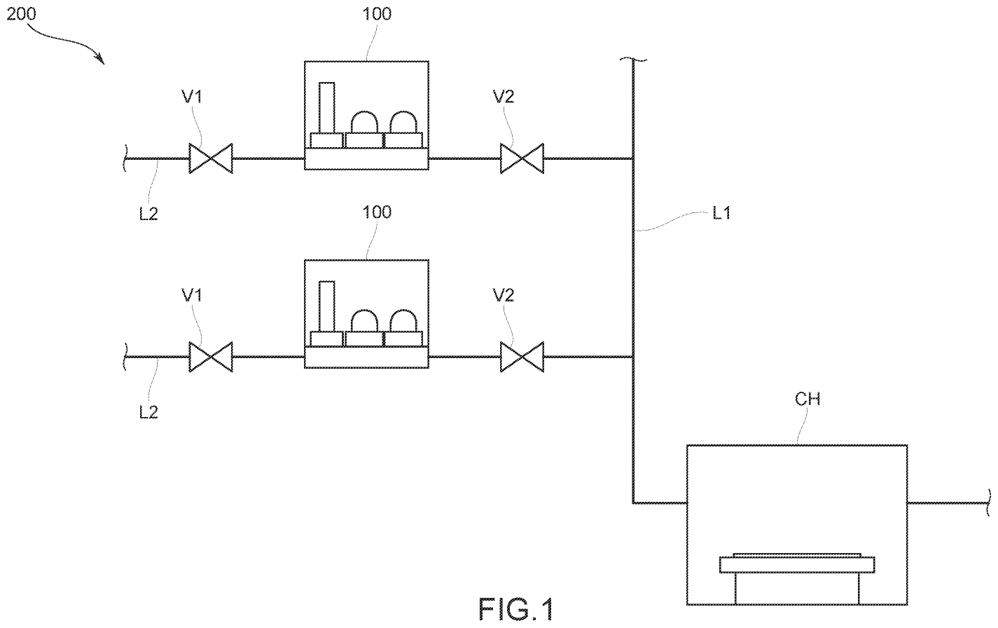

A fluid control device 100 of the present embodiment is used, for example, in a semiconductor manufacturing process, and constructs a fluid control system 200 that controls the flow rate of the fluid supplied to the process chamber CH as illustrated in FIG. 1.

In the fluid control system 200, the above-described fluid control device 100 is disposed in a part or all of a plurality of flow paths L2 (hereinafter, also referred to as a branch flow path L2) provided in parallel, and the downstream of the plurality of branch paths L2 is connected to, for example, the main flow path L1 communicating with the process chamber CH. Note that the main flow path L1 is a flow path that can suddenly have a higher pressure than the inside of the fluid control device 100. The shut-off valves V1 and V2 are provided on the upstream side and the downstream side of the fluid control device 100 in the branch flow path L2, respectively.

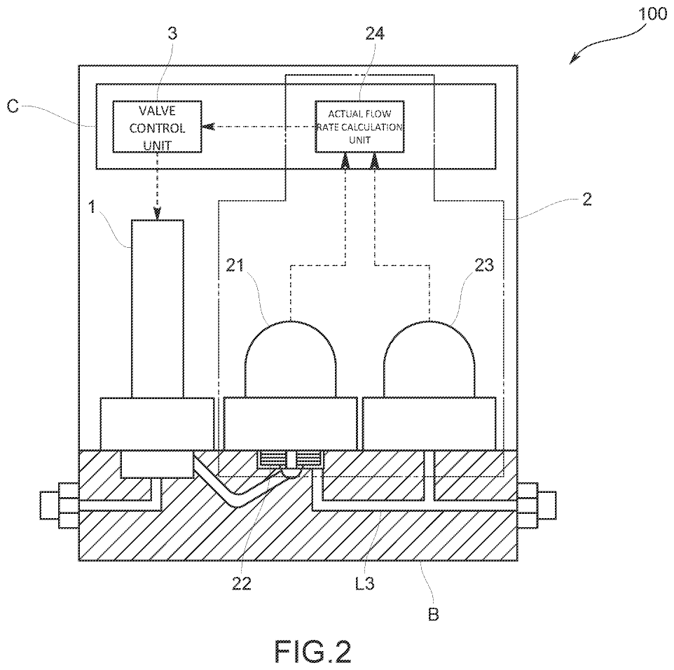

As illustrated in FIG. 2, the fluid control device 100 is a differential pressure type mass flow controller in which a fluid control valve 1, an upstream pressure sensor 21, a fluid resistance element 22, and a downstream pressure sensor 23 are arranged in this order from the upstream side, and a control unit C that controls the fluid control valve 1 is packaged together with these fluid instruments. More specifically, the mass flow controller 100 includes a block B in which an internal flow path L3 is formed, the above-described various fluid devices are attached to the block B, and a fluid having a lower pressure than the above-described main flow path L1 flows through the internal flow path L3. In the fluid control device 100, a pressure sensor may be further provided on the upstream side of the fluid control valve 1.

The control unit C is a so-called computer including a CPU, a memory, an A/D converter, a D/A converter, and various input/output devices, and functions as at least the actual flow rate calculation unit 24 and the valve control unit 3 by executing a fluid control device program stored in the memory as illustrated in FIG. 2.

The actual flow rate calculation unit 24 calculates the flow rate of the fluid flowing through the internal flow path L3 from the measured pressures measured by the upstream pressure sensor 21 and the downstream pressure sensor 23. That is, the upstream pressure sensor 21, the fluid resistance element 22, the downstream pressure sensor 23, and the flow rate calculation unit constitute a differential pressure-type flow rate sensor 2. The calculated flow rate calculated by the actual flow rate calculation unit 24 is output to the valve control unit 3 as a measured flow rate.

The valve control unit 3 performs flow rate feedback control on the opening degree of the fluid control valve 1 so that the deviation between the set flow rate set by a user and the calculated flow rate calculated by the actual flow rate calculation unit 24 becomes small.

Here, when a large flow flows into the main flow path L1 in a state where the fluid control valve 1 described above is closed and the shut-off valve V2 provided downstream is open, the fluid may flow back from the main flow path L1 to the mass flow controller 100 via the branch flow path L2. Then, the pressure measured by the downstream pressure sensor 23 increases, and the pressure measured by the upstream pressure sensor 21 increases by a time difference caused by the fluid resistance element 22.

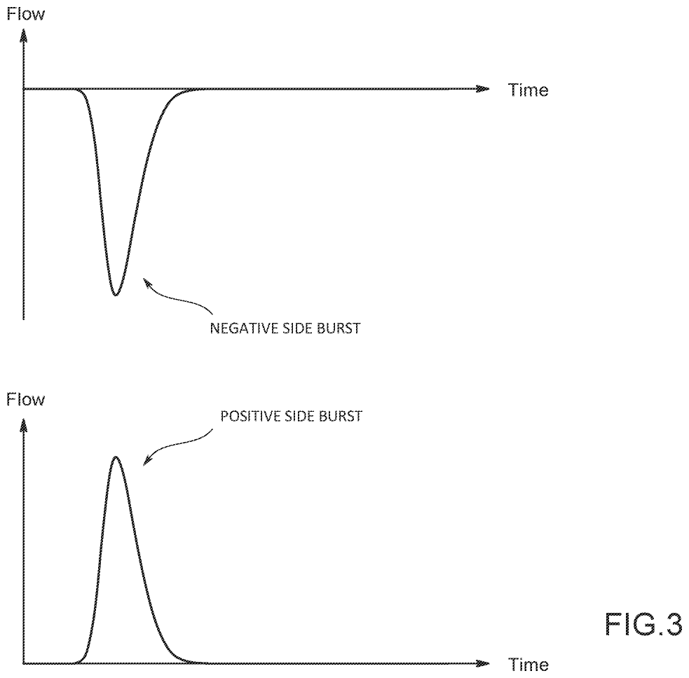

As a result, a difference occurs between the pressures measured by the upstream pressure sensor 21 and the downstream pressure sensor 23, and thus, as illustrated in the upper part of FIG. 3, the calculated flow rate corresponding to the pressure difference is output even though the fluid control valve 1 is closed (hereinafter, this phenomenon is also referred to as a burst). Note that the burst in this case appears on the negative side.

On the other hand, as illustrated in the lower part of FIG. 3, a burst may appear on the positive side, and the following can be exemplified as one of the causes.

When the shut-off valve V2 is opened from a state in which the fluid control valve 1 is closed and the shut-off valve V2 provided downstream of the mass flow controller 100 is closed, the fluid remaining in the internal flow path L3, the branch flow path L2, and the like of the mass flow controller 100 flows out to the main flow path L1. Then, the pressure measured by the downstream pressure sensor 23 decreases, and the pressure measured by the upstream pressure sensor 21 decreases by a time difference caused by the fluid resistance element 22.

As a result, a difference occurs between the pressures measured by the upstream pressure sensor 21 and the downstream pressure sensor 23, and thus, as illustrated in the lower part of FIG. 3, a calculated flow rate corresponding to the pressure difference is output even though the fluid control valve 1 is closed.

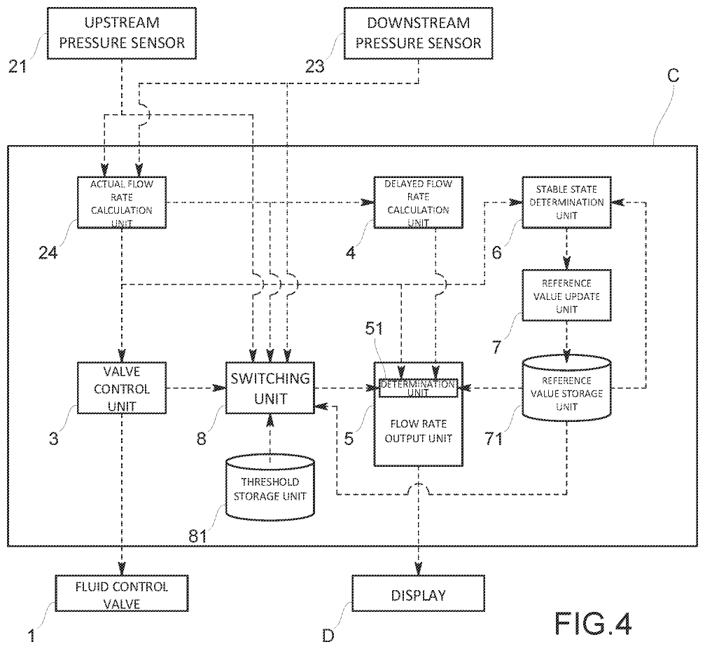

Therefore, in order to suppress the burst described above, as illustrated in FIG. 4, the control unit C of the present embodiment further includes a function as a delayed flow rate calculation unit 4 that calculates a delayed flow rate that has caused a response delay in the calculated flow rate.

The delayed flow rate calculation unit 4 is configured using a low-pass filter, and calculates a delayed flow rate obtained by generating a first-order delay in the calculated flow rate. Note that the low-pass filter may be an analog low-pass filter configured using a resistive element and a capacitive element, or may be a digital low-pass filter created by a program.

In the present embodiment, the time constant is set to a different value between the case where the fluid flows from the upstream side to the downstream side in the fluid resistance element 22 and the case where the fluid flows in the opposite direction, that is, the time constant is set to a different value between the case where the calculated flow rate bursts to the negative side and the case where the calculated flow rate bursts to the positive side. In other words, the time constant of the response delay is set to a different value depending on whether or not the pressure measured by the upstream pressure sensor 21 is greater than the pressure measured by the downstream pressure sensor 23. Specifically, the time constant of when the calculated flow rate is positive is set to be larger than the time constant of when the calculated flow rate is negative. However, the time constant of when the calculated flow rate is positive may be set to be smaller than the time constant of when the calculated flow rate is negative, or these time constants may be set to the same value.

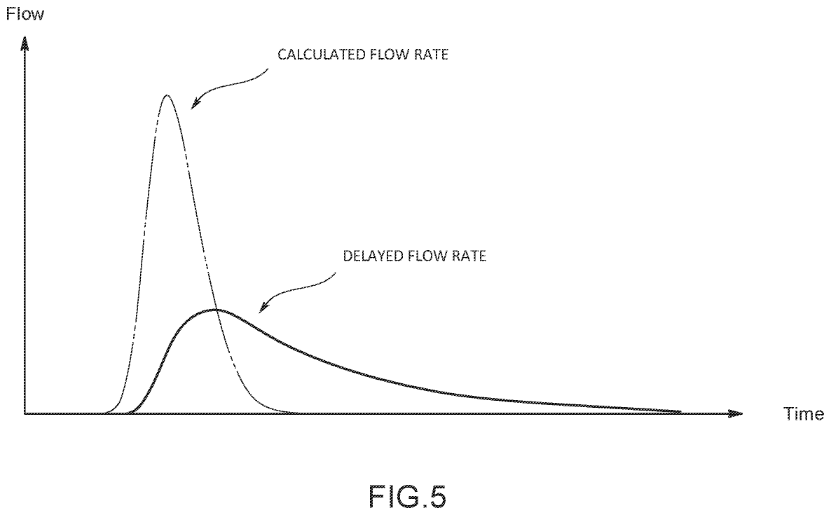

In this way, by generating the response delay in the calculated flow rate, the burst is suppressed as indicated by the solid line in FIG. 5. Although FIG. 5 illustrates a state in which the burst on the positive side is suppressed, the burst on the negative side can be similarly suppressed. However, on the other hand, regarding the delayed flow rate calculated by the delayed flow rate calculation unit 4, the time for stabilizing the flow rate at the original flow rate (zero in FIG. 5) before occurrence of the burst is longer than the calculated flow rate.

Thus, as illustrated in FIG. 4, the control unit C of the present embodiment further includes a function as the flow rate output unit 5 that compares the absolute difference between the predetermined reference value and the calculated flow rate and the absolute difference between the reference value and the delayed flow rate, and outputs the calculated flow rate or the delayed flow rate having the smaller absolute difference. That is, as illustrated in FIG. 4, the flow rate output unit 5 has a function as a determination unit 51 that determines the flow rate to be output by comparing the absolute difference between the reference value and the calculated flow rate and the absolute difference between the reference value and the delayed flow rate.

More specifically, the flow rate output unit 5 outputs the flow rate in the flow rate sensor 2, that is, the above-described calculated flow rate to the display D or the like, for example, in a steady state in a semiconductor manufacturing process, and is configured to output the flow rate on a real time basis as a graph in which time is set on a horizontal axis and a flow rate is set on a vertical axis, for example. Note that the flow rate output unit 5 may be configured to be able to transmit the calculated flow rate as numerical information to the user side via a communication unit (not illustrated).

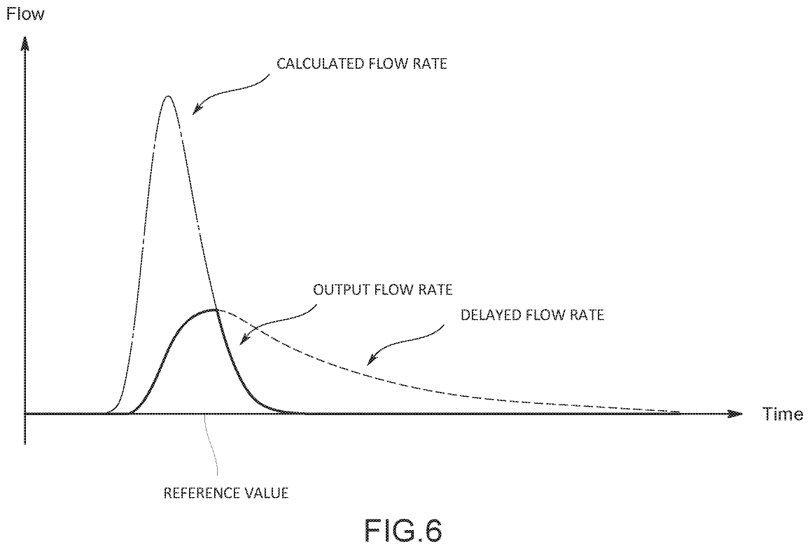

The flow rate output unit 5 is configured to output the flow rate closer to the reference value out of the calculated flow rate and the delayed flow rate as indicated by a solid line in FIG. 6 when the predetermined condition is satisfied. Hereinafter, this function of the flow rate output unit 5 is referred to as a burst cutting function.

Here, FIG. 6 illustrates a state in which the reference value is set to zero, but the control unit C of the present embodiment has functions as a stable state determination unit 6 and a reference value update unit 7 for updating the reference value described above.

Furthermore, the control unit C of the present embodiment further includes a function as the switching unit 8 for enabling (ON) or disabling (OFF) the burst cutting function according to a predetermined condition.

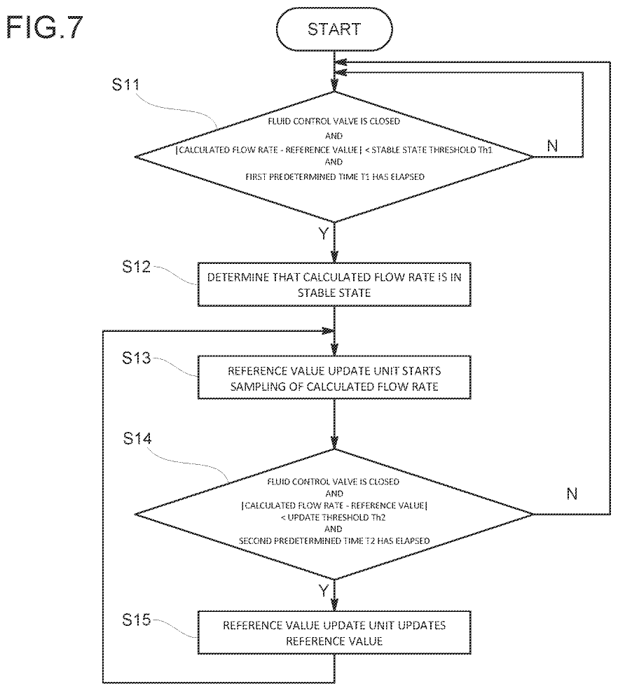

First, the function and operation for updating the reference value will be described with reference to the flowchart of FIG. 7.

For example, at the time of factory shipment or the like, if the fluid does not flow in the flow rate sensor 2, the output value output as the calculated flow rate should be zero, and if the reference value is set to zero as illustrated in FIG. 6, the burst cutting function by the flow rate output unit 5 can be effectively exerted.

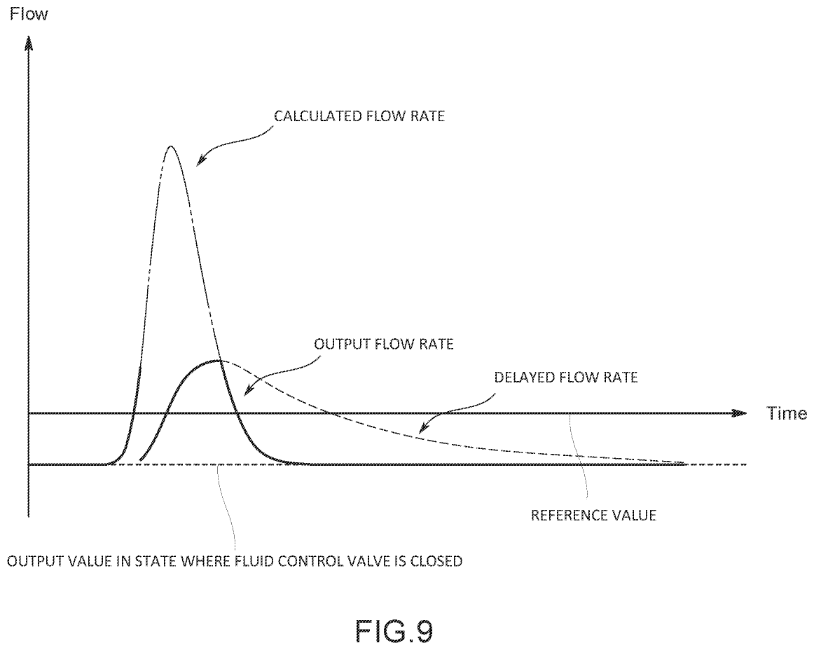

However, the output value in the state in which the fluid control valve 1 is closed may vary slightly over time. Therefore, as shown in FIG. 9, if the output value in a state where the fluid control valve is closed has been shifted to a negative value, the calculated flow rate becomes closer to zero than the delayed flow rate at the beginning of the burst occurrence while the reference value is set to zero, so that the calculated flow rate is output and the waveform (solid line in FIG. 9) of the output flow rate becomes irregular, whereby the burst cutting function cannot be effectively exerted.

Therefore, the control unit C of the present embodiment is configured to sequentially update the reference value as described above.

However, for example, when the fluid control valve 1 is switched from the open state to the closed state, the calculated flow rate is not stabilized immediately after the fluid control valve 1 is closed, and it is not desirable to update the reference value in the transient state.

In view of this, as shown in FIG. 7, first, the stable state determination unit 6 determines whether or not the fluid control valve 1 is closed and the absolute difference between the calculated flow rate and the reference value falls below the predetermined stable state threshold Th1 over the first predetermined time T1 (S11), and when the absolute difference falls below the predetermined stable state threshold Th1, the stable state determination unit 6 determines that the calculated flow rate is in the stable state (S12).

In the present embodiment, for example, an initial reference value at the time of factory shipment or the like is set to, for example, zero, and the first predetermined time T1 is set to, for example, several tens of seconds. That is, the stable state determination unit 6 of the present embodiment determines that the calculated flow rate is in the stable state when the absolute difference between the calculated flow rate and zero falls below the predetermined stable state threshold Th1 for several tens of seconds, for example. When the absolute difference between the calculated flow rate and the reference value does not fall below the predetermined stable state threshold Th1 over the predetermined time, the determination in S11 is repeated.

Next, after it is determined that the calculated flow rate is in a stable state, the reference value update unit 7 updates the reference value.

More specifically, the reference value update unit 7 starts sampling the calculated flow rate over the second predetermined time T2 after the stable state determination unit 6 determines that the calculated flow rate is in the stable state (S13). Then, the reference value update unit 7 determines whether or not the fluid control valve 1 is closed and the absolute difference between the calculated flow rate sampled in S13 and the reference value falls below the update threshold Th2 over the second predetermined time T2 (S14), and updates one of the sampled calculated flow rates as a new reference value when the absolute difference falls below the update threshold Th2 (S15). Note that the first predetermined time T1 and the second predetermined time T2 may be the same or different.

The reference value update unit 7 of the present embodiment is configured to update the latest (most recent) calculated flow rate among the sampled calculated flow rates as a new reference value. The reference value update unit 7 may update the average value of the sampled calculated flow rates as a new reference value, or may update the lowest calculated flow rate among the sampled calculated flow rates as a new reference value.

Thereafter, the sampling in S13 and the determination in S14 by the reference value update unit 7 are repeated.

In the present embodiment, as illustrated in FIG. 4, the reference value updated by the reference value update unit 7 is temporarily stored in a reference value storage unit 71 formed in a predetermined region of the memory, and the reference value stored in the reference value storage unit 71 is output to the determination unit 51 of the flow rate output unit 5 and used for the determination of the burst cutting function by the flow rate output unit 5.

In S14, when the absolute difference between the sampled calculated flow rate and the reference value does not fall below the update threshold Th2 over the second predetermined time T2, that is, when the absolute difference between at least one of the sampled calculated flow rates and the reference value becomes equal to or greater than the update threshold Th2, the reference value stored in the reference value storage unit 71 at that time is not updated, and the processing returns to the determination in S11 by the stable state determination unit 6.

With the above-described configuration, the stable output value at that time in the state where the fluid control valve 1 is closed can be updated as the reference value, and the reference value can be continuously set to an appropriate value, so that the burst cutting function can be effectively exerted.

Furthermore, sampling of the calculated flow rate by the reference value update unit 7 is not started until the calculated flow rate is stabilized, and it is possible to prevent the calculated flow rate in an unstable state from being set as the reference value.

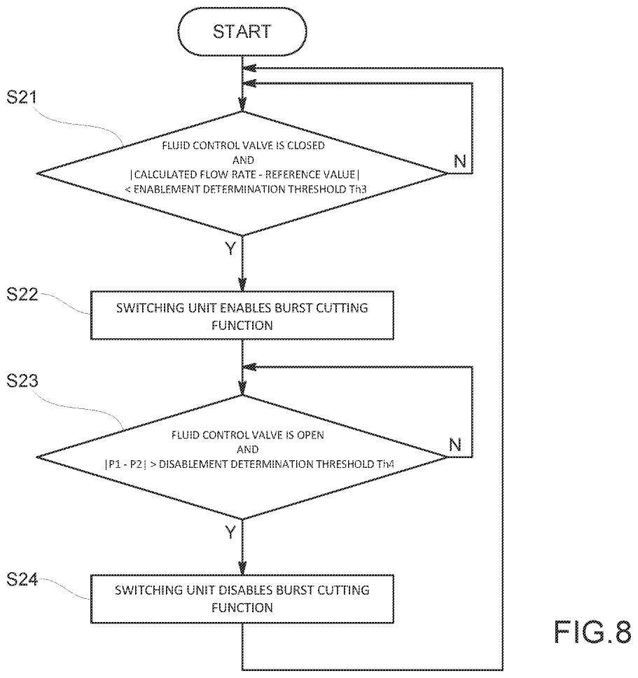

Next, a function and operation for enabling (ON) or disabling (OFF) the burst cutting function will be described with reference to the flowchart of FIG. 8.

As described above, since the calculated flow rate is unstable immediately after the fluid control valve 1 is closed, it is preferable that the function of the flow rate output unit 5 is not exerted at this time point.

On the other hand, immediately after the fluid control valve 1 is opened, there is a possibility that the fluid remaining inside flows backward to the upstream side and the flow rate on the negative side is unexpectedly output and it is preferable to keep exerting the function of the flow rate output unit 5 in order to suppress this burst.

Therefore, the control unit C of the present embodiment is configured such that the switching unit 8 enables or disables the burst cutting function by the flow rate output unit 5 on the basis of a predetermined condition (an enablement condition and a disablement condition to be described later). That is, the switching unit 8 switches whether or not to cause the determination unit 51 of the flow rate output unit 5 described above to compare the absolute differences.

More specifically, the switching unit 8 determines whether or not the fluid control valve 1 is in the closed state and the absolute difference between the calculated flow rate and the reference value falls below the enablement determination threshold Th3 (hereinafter, also referred to as an enablement condition) (S21), and enables the burst cutting function by the flow rate output unit 5 when this enablement condition is satisfied (S22). That is, when this enablement condition is satisfied, the flow rate output unit 5 outputs the flow rate closer to the reference value out of the calculated flow rate and the delayed flow rate. As illustrated in FIG. 4, the enablement determination threshold Th3 is stored in advance in a threshold storage unit 81 set in a predetermined area of the memory.

With such a configuration, immediately after the fluid control valve 1 is closed, the function of the flow rate output unit 5 can be enabled after the calculated flow rate is stabilized.

Thereafter, the switching unit 8 determines whether or not the fluid control valve 1 is in the open state and the value obtained by subtracting the measured pressure P2 of the downstream pressure from the measured pressure P1 of the upstream pressure sensor 21 exceeds the disablement determination threshold Th4 (hereinafter, also referred to as a disablement condition) (S23). When this disablement condition is satisfied, the switching unit 8 disables the burst cutting function by the flow rate output unit 5 (S24). That is, when the disablement condition is satisfied, the flow rate output unit 5 outputs the calculated flow rate without outputting the delayed flow rate. As illustrated in FIG. 4, the disablement determination threshold Th4 is stored in advance in the threshold storage unit 81.

With such a configuration, immediately after the fluid control valve 1 is opened, it is possible to disable the function of the flow rate output unit 5 after there is no possibility of the burst due to the reverse flow of the fluid remaining inside, in other words, it is possible to suppress such a burst.

Thereafter, the operations of S21 to S24 by the switching unit 8 are repeated.

### Effects of Present Embodiment

According to the fluid control device 100 configured as described above, since the flow rate output unit 5 outputs the flow rate having the smaller absolute difference from the reference value among the calculated flow rate and the delayed flow rate, in a case where an unexpected flow rate is output due to, for example, backflow to the fluid control device 100, a delayed flow rate closer to the reference value than the calculated flow rate is output at the beginning. Thereafter, since the calculated flow rate is more quickly stabilized, the calculated flow rate overtakes the delayed flow rate and approaches the reference value at a certain time point, and from that time point, a calculated flow rate that is quickly stabilized is output.

As described above, according to the fluid control device 100 of the present invention, the delayed flow rate closer to the reference value than the calculated flow rate is output at the beginning of the burst, and the calculated flow rate that is rapidly stabilized from a certain time point at which the absolute difference from the reference value is reversed is output, whereby it is possible to quickly stabilize the output flow rate while suppressing the accidentally output flow rate.

### Other Embodiments

For example, the delayed flow rate calculation unit 4 generates a first-order delay in the calculated flow rate in the above embodiment, but may generate a second-order delay in the calculated flow rate.

The switching unit 8 of the above embodiment enables the burst cutting function when the fluid control valve 1 is in the closed state and the absolute difference between the calculated flow rate and the reference value falls below the enablement determination threshold Th3, but the switching unit 8 may enable the burst cutting function when the fluid control valve 1 is in the closed state and a predetermined time has elapsed since the fluid control valve 1 went into the closed state.

Further, the switching unit 8 of the above embodiment disables the burst cutting function when the fluid control valve 1 is in the open state and the value obtained by subtracting the measured pressure P2 of the downstream pressure from the measured pressure P1 of the upstream pressure sensor 21 exceeds the disablement determination threshold Th4, but the switching unit 8 may disable the burst cutting function when the fluid control valve 1 is in the open state and a predetermined time has elapsed since the fluid control valve 1 went into in the open state.

In addition, in the above embodiment, the fluid control device 100 has been described as being used in a semiconductor manufacturing process, but the fluid control device 100 according to the present invention can be used in various systems other than the semiconductor manufacturing process.

In addition, various modifications and combinations of the embodiments may be made without departing from the gist of the present invention.

### INDUSTRIAL APPLICABILITY

According to the present invention, it is possible to quickly stabilize the output flow rate while suppressing the accidentally output flow rate.

### REFERENCE CHARACTER LIST

100 fluid control device (mass flow controller)
1 fluid control valve
21 upstream pressure sensor
22 fluid resistance element
23 downstream pressure sensor
L3 internal flow path
C control unit
24 actual flow rate calculation unit
2 flow rate sensor
3 valve control unit
4 delayed flow rate calculation unit
5 flow rate output unit
51 determination unit
6 stable state determination unit
7 reference value update unit
8 switching unit

1. A fluid control device in which a fluid control valve, an upstream pressure sensor, a fluid resistance element, and a downstream pressure sensor are arranged in this order from an upstream side, the fluid control device comprising:
an actual flow rate calculation unit that calculates a flow rate on basis of pressures measured by the upstream pressure sensor and the downstream pressure sensor;
a delayed flow rate calculation unit that calculates a delayed flow rate by generating a response delay in the calculated flow rate calculated by the actual flow rate calculation unit; and
a flow rate output unit that compares an absolute difference between a predetermined reference value and the calculated flow rate and an absolute difference between the reference value and the delayed flow rate, and outputs the calculated flow rate or the delayed flow rate having a smaller absolute difference.

2. The fluid control device according to claim 1, further comprising a reference value update unit that updates the reference value at predetermined time intervals.

3. The fluid control device according to claim 2, wherein the reference value update unit samples the calculated flow rate over a predetermined time, and updates one of the sampled calculated flow rates as a new reference value when an absolute difference between the calculated flow rate and the reference value falls below an update threshold over the predetermined time.

4. The fluid control device according to claim 3, further comprising a stable state determination unit that determines that the calculated flow rate is in a stable state when an absolute difference between the calculated flow rate and the reference value falls below a stable state threshold over a predetermined time, wherein
sampling of the calculated flow rate by the reference value update unit is started after the stable state determination unit determines the stable state.

5. The fluid control device according to claim 1, further comprising a switching unit that switches whether or not to cause the flow rate output unit to compare the absolute differences.

6. The fluid control device according to claim 5, wherein the switching unit enables a function of the flow rate output unit when the fluid control valve is in a closed state and an absolute difference between the calculated flow rate and the reference value falls below an enablement determination threshold.

7. The fluid control device according to claim 5, wherein the switching unit disables a function of the flow rate output unit when the fluid control valve is in an open state and a value obtained by subtracting the pressure measured by the downstream pressure sensor from the pressure measured by the upstream pressure sensor exceeds a disablement determination threshold.

8. The fluid control device according to claim 1, wherein a time constant of the response delay generated by the delayed flow rate calculation unit is different between a case where a fluid flows from the upstream side to a downstream side in the fluid resistance element and a case where a fluid flows in a direction opposite thereto.

9. A fluid control system, wherein the fluid control device according to claim 1 is disposed in a part or all of a plurality of branch flow paths connected to a main flow path and provided in parallel.

10. A non-transitory storage medium storing a program used for a fluid control device in which a fluid control valve, an upstream pressure sensor, a fluid resistance element, and a downstream pressure sensor are arranged in this order from an upstream side, the program causing a computer to function as:
an actual flow rate calculation unit that calculates a flow rate on basis of pressures measured by the upstream pressure sensor and the downstream pressure sensor;
a delayed flow rate calculation unit that calculates a delayed flow rate by generating a response delay in the calculated flow rate calculated by the actual flow rate calculation unit; and
a flow rate output unit that compares an absolute difference between a predetermined reference value and the calculated flow rate and an absolute difference between the reference value and the delayed flow rate, and outputs the calculated flow rate or the delayed flow rate having a smaller absolute difference.

11. A fluid control method used for a fluid control device in which a fluid control valve, an upstream pressure sensor, a fluid resistance element, and a downstream pressure sensor are arranged in this order from an upstream side, the fluid control method comprising:
an actual flow rate calculation step of calculating a flow rate on basis of pressures measured by the upstream pressure sensor and the downstream pressure sensor;
a delayed flow rate calculation step of calculating a delayed flow rate by generating a response delay in the calculated flow rate calculated in the actual flow rate calculation step; and
a step of comparing an absolute difference between a predetermined reference value and the calculated flow rate and an absolute difference between the reference value and the delayed flow rate, and outputting the calculated flow rate or the delayed flow rate having a smaller absolute difference.
